(19) United States
(12) Patent Application Publication
(10) Pub. No.: US 2024/0123512 A1
(43) Pub. Date: Apr. 18, 2024

(54) Cutting tool

(71) Applicant: Gühring KG, Albstadt (DE)

(72) Inventor: Guido Kuhli, Bad Laasphe (DE)

(73) Assignee: Gühring KG, Albstadt (DE)

(21) Appl. No.: 18/486,193

(22) Filed: Oct. 13, 2023

(30) Foreign Application Priority Data
Oct. 14, 2022 (DE) 10 2022 126 883.7

(51) Int. Cl. B23B 27/10

(52) U.S. Cl. CPC B23B 27/10

(57) ABSTRACT

A one or multiple cutting edge machining tool, in particular milling, reaming or drilling tool, includes a tool body (12), which extends along a central tool axis and which has at least one cutting web (20), which carries a cutting insert (22), which protrudes radially beyond a circumferential jacket surface (21) of the cutting web (20) and which cuts at least circumferentially, and an integrated coolant channel system, which has a main channel (28) guided along the tool axis (11) and, for each cutting web (20), at least one branch channel (29, 29a, 29b), which branches off the main channel (28) and which is guided through the cutting web (20). The at least one branch channel (29, 29a, 29b), which is guided exclusively through the cutting web (20), has a mouth opening (30, 30a, 30b), which lies in the jacket surface (21) of the cutting web (20).

### CROSS-REFERENCE TO RELATED APPLICATION

This application claims the benefit of German Patent Application DE 10 2022 126 883.7, filed on Oct. 14, 2022, the contents of which is hereby incorporated in its entirety.

### TECHNICAL FIELD

The disclosure relates to a machining tool, in particular a milling tool.

### BACKGROUND

A machining tool is known, for example, from the EP 2 962 796 B1. The EP 2 962 796 B1 shows and describes in particular a machining tool, in particular milling, reaming or drilling tool, comprising a tool body, which extends along a central tool axis and which has at least one cutting web, which carries a rod-shaped cutting insert, which protrudes radially beyond a circumferential jacket surface of the cutting web and which has a free surface or round bevel surface and which is formed as a massive body of PCD or CBN (solid PCD or solid CBN) or as a composite body consisting of a hard metal carrier comprising PCD or CBN coating. To improve the cooling, chip removal as well as lubrication of the at least one cutting insert, a central main channel, which is guided through the tool body, is to form a connection to at least one coolant channel section, which is incorporated into the cutting insert, comprising at least one mouth opening in the round bevel surface and/or free surface of the cutting insert, via a branch channel, which branches off from the main channel.

While the central main channel and the branch channel branching off from the main channel, in the tool body, which, compared to the cutting insert, is routinely manufactured from a ductile material, can be created by means of a drilling, which can be carried out easily, the cutting insert has to be machined by means of a technically more complex spark erosion or laser method in order to introduce the coolant channel section. The machining tool specified in the EP 2 962 796 B1 thus requires different material-removing methods, in order to completely form the coolant channel system, which is guided through the tool body and the cutting insert.

The improvement of the cooling, chip removal, and lubrication strived for according to the EP 2 962 796 B1 furthermore requires a reliable continuous and loss-free coolant supply all the way to the mouth opening at the free surface or round bevel of the cutting insert, which, in turn, requires a positionally accurate fastening of the cutting insert on the tool body in such a way that the coolant channel section incorporated into the cutting insert is seamlessly aligned with the branch channel, which is guided through the cutting web. The proposed machining tool thus requires a positionally accurate arrangement of the cutting insert on the cutting web of the tool body. A slit-shaped pocket receiving the cutting insert thus has to thus be formed in an extremely precise manner.

The completion of the machining tool is thus complex and cost-intensive as a whole.

As aperture, the coolant channel section, which is guided through the hard material, additionally weakens the cutting insert. The rod-shaped cutting insert thus requires a sufficiently large rod thickness, in order to be able to withstand the forces acting on the cutting insert during the machining of a tool in spite of the coolant channel section.

Exactly the same considerations or difficulties, respectively, apply for a machining tool specified in EP 2 266 739 B1, in the case of which a mouth opening of a coolant channel section, which is guided through a cutting insert, lies in a cutting surface of a cutting insert.

CZ 2010903 A3 discloses a machining tool, in the case of which a coolant channel guided through a cutting web is formed from a radially running branch channel and a following channel, which is connected to the branch channel and which is aligned at a distance upstream of the jacket surface of the cutting web towards the cutting insert lying ahead in the direction of rotation of the tool and opens out into a groove formed in the free surface of the cutting insert. In the cutting web, a coolant supplied to the cutting insert thus experiences a deflection towards the groove formed in the free surface. The completion of the machining tool specified in the CZ 2010903 A3 is thus likewise complex and cost-intensive.

### SUMMARY

The disclosure provides a machining tool (cutting tool), in particular milling, reaming or drilling tool, which can be manufactured economically, and which is characterized by a good cooling and good chip removal.

A machining tool according to the disclosure, in particular milling, reaming or drilling tool, has a tool body, which extends along a central tool axis and which has at least one cutting web, which carries an at least circumferentially cutting cutting insert, which protrudes radially beyond a circumferential jacket surface of the cutting web, and an integrated coolant channel system, which has a main channel guided along the tool axis and, for each cutting web, at least one branch channel, which branches off from the main channel and which is guided through the cutting web. The at least one branch channel has a mouth opening, which lies in a jacket surface of the cutting web.

The at least one branch channel for each cutting web runs exclusively through or completely within the assigned cutting web, respectively, but no longer through the cutting insert. The branch channel thus does not cause a weakling of the cutting insert, which is advantageously formed of a brittle-hard material. Compared to the above-discussed prior art, it can thus be embodied with a smaller thickness.

Due to the fact that the at least one branch channel no longer extends into the or through the cutting insert, respectively, above-mentioned alignment errors are furthermore also ruled out and a continuous loss-free coolant supply all the way to the mouth opening is ensured.

Due to the fact that the cutting insert is routinely arranged on a side of the cutting web, which is located in the front in the direction of rotation of the tool, i.e. on the chip flute side, the mouth opening of the at least one branch channel, which lies in the jacket surface of the cutting web, is arranged downstream from the cutting insert in the direction of rotation of the tool and thus downstream from a circumferential cutting edge and free surface formed on the cutting insert. To improve the cooling and chip removal, the mouth opening preferably lies in the region of the longitudinal extension of the circumferential cutting edge of the cutting insert, viewed in the axial direction, i.e. in a region in which chips are created on the circumferential cutting edge during a machining of a workpiece.

Due to the fact that the jacket surface of the cutting web is radially recessed with respect to the cutting edge carrier section of the cutting insert, which has the circumferential cutting edge and free surface, the mouth opening additionally lies on a smaller diameter than the cutting edge carrier section of the cutting insert, which protrudes radially beyond the jacket surface. Coolant escaping at the mouth opening can thus be distributed over a large surface in the radial gap between the jacket surface of the cutting web and the workpiece surface to be machined and can contribute to a good cooling of the cutting insert, which is arranged on the cutting web.

Due to the fact that the branch channel runs through the cutting web, the at least one branch channel can be secured to the cutting web with respect to its position in the cutting web, its alignment or its course relative to the central tool axis, respectively, and its flow cross section, in particular diameter, regardless of the size and position of the cutting insert in such a way that a good cooling of the cutting part and a good chip removal are obtained during a machining of a workpiece.

At least in a length section, which forms the mouth opening, each branch channel can be placed at a defined angle to the tool axis. The flow direction of the coolant jet escaping at the mouth opening and thus the chip flow of the chips created at the circumferential cutting edge can be determined via the defined angle.

At least one length section of the at least one branch channel forming the mouth opening can advantageously be placed at an angle in the range of 50° to 60°, preferably 55°, to the tool axis and in particular so that it is oriented away from the shaft in the direction of the tool front side, in order to direct the chips created at the circumferential cutting edge in the direction of the tool front side.

From a manufacturing aspect, the main channel and/or the at least one branch channel are/is preferably embodied in a straight line. The main channel and the at least one branch channel can in particular be embodied as bores, which lead from the jacket surface through the cutting web all the way to the central main channel and which can be produced easily from a manufacturing aspect.

In a preferred embodiment, the main channel is guided centrally through the tool body along the tool axis and the main channel ends at a defined distance upstream of the tool front side. The entire coolant supplied via the main channel is thus distributed to the at least one branch channel. The at least one branch channel can thus lie in a longitudinal sectional plane containing the tool axis.

In terms of a good chip removal, a flow cross sectional surface of the at least one branch channel at least in the region of the jacket-side mouth opening is advantageously designed so that the flow pressure of a coolant jet escaping at the mouth opening of the at least one branch channel is higher than the flow pressure of the coolant flowing through the main channel. The mouth opening of the at least one branch channel can thus be understood as nozzle, out of which the coolant is ejected. This means that a clear cross section of the central main channel is larger than a clear cross section of the at least one branch channel or, in the event that several branch channels branch off the central main channel and in each case have a jacket-side mouth opening, than the sum of the clear cross sections of the several branch channels. A flow pressure increase at the mouth opening of the at least one branch channel can be attained or at least a flow pressure drop can be prevented in this way.

In a preferred embodiment, the tool body has more than one cutting web, in particular four cutting webs, which are arranged around the tool axis with even or uneven distribution, spaced apart from one another by means of clamping grooves, and in each case carry an at least circumferentially cutting cutting insert. As a whole, i.e. in sum, the flow cross sectional surfaces of the branch channels are, at least in the region of the jacket-side mouth openings, designed in this case so that the escaping coolant jets escape with an excess pressure compared to the flow pressure of the coolant entering the main channel.

In a preferred embodiment, the tool body is functionally divided into a shaft for clamping into a tool holder and a cutting part having the at least one cutting web, wherein the main channel is guided through the shaft into the cutting part.

In a preferred embodiment, the at least one cutting web has a seat, which receives the cutting insert, preferably in a positive manner, comprising a support surface, which runs parallel to the tool axis and which lies upstream of a longitudinal sectional plane, which contains the tool axis, (i.e. “over center”) in the direction of rotation of the tool.

In a preferred embodiment, a circumferential cutting edge formed on the cutting insert furthermore lies upstream of a longitudinal sectional plane, which includes the tool axis, (i.e. “over center”), in the direction of rotation of the tool.

The cutting insert or the cutting inserts can be formed as massive bodies consisting of PCD or CBN (solid PCD or solid CBN) or as composite bodies consisting of a hard metal carrier comprising a PCD or CBN coating and can be fastened to the respective cutting web by means of soldering.

Preferred embodiments of a machining tool will be introduced below with reference to the enclosed drawings.

### BRIEF DESCRIPTION OF THE DRAWINGS

FIG. 1 shows a perspective side view of a machining tool according to a first embodiment,

FIG. 2 shows a side view of the machining tool according to the first embodiment,

FIG. 3 shows a longitudinal sectional view of the machining tool according to the first embodiment,

FIG. 4a shows a front view of the machining tool according to the first embodiment,

FIG. 4b shows an illustration, which is enlarged in scale, of a detail A from FIG. 4a, and

FIG. 5 shows a longitudinal sectional view of a machining tool according to a second embodiment.

### DETAILED DESCRIPTION

### First Embodiment

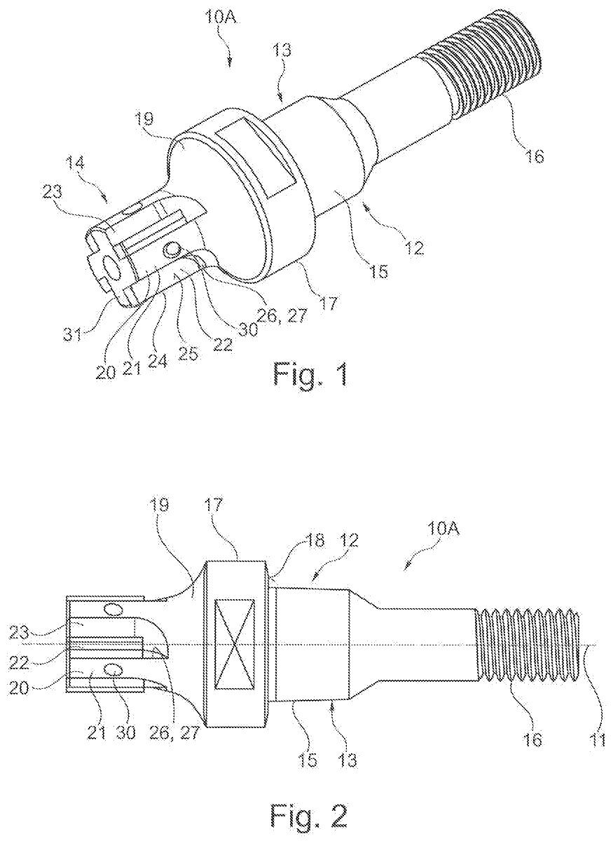

FIGS. 1 to 4b schematically show a machining tool according to a first embodiment, which is formed in an exemplary manner as an end milling cutter 10, in particular for milling the ball windows or the ball contact surfaces of the windows, respectively, of a ball cage. It is important to emphasize at this point that it goes without saying that the machining tool can be prepared for other intended uses, such as, e.g., reaming, drilling out, or drilling.

The end milling cutter 10A comprises a tool body 12, which extends along a central tool axis 11 and which can be functionally divided into a shaft 13 and a cutting part 14.

In the shown embodiment, the shaft 13 of the tool body 12 has an external conical clamping section 15, which can be retracted into an inner conical receiving section of a (non-illustrated) tool holder and to which an external thread section 16 is connected, which is to be screwed in the tool holder by means of a screw drive. A collar 17, the diameter of which is enlarged and which has, on its side facing the shaft 13, a ring-shaped stop surface 18 for striking against a tool holder-side stop and which, on its side facing the cutting part 14, merges into the cutting part 14 via a tapering section 19, connects to the shaft 13 in the direction of the cutting part 14. However, the design of the shaft 13 and the arrangement of the collar 17 or tapering section 19, respectively, may be modified. The shaft 13 has to only be embodied so that it can be clamped into common tool holders (tool receptacles or clamping chucks, respectively), which are known to the person of skill in the art. For example, the shaft 13 can be embodied as a cylindrical shaft or a conical shaft.

In the shown embodiment, the cutting part 14 of the tool body 12 has four cutting webs 20, which are distributed around the tool axis 11 at regular intervals of 90° and which in each case carry a circumferentially cutting cutting insert 22, which protrudes radially beyond a circumferential jacket surface 21 of the cutting web 20. It is important to point out at this point that the number of the cutting webs 20 is variable. The machining tool has at least one cutting web 20, and may include more than one cutting web 20. The cutting webs 20 are separated from one another by means of clamping grooves 23, which run in a straight line and along the tool axis 11 in the shown embodiment, but which can generally also run helically around the tool axis 11.

In the shown embodiment, the jacket surfaces 21 of the cutting webs 20 in each case lie on a cylindrical surface around the axis of rotation 11 of the tool.

Each cutting web 20 carries a cutting insert 22, which cuts circumferentially in the shown embodiment and which protrudes radially beyond the jacket surface 21 of the assigned cutting web 21 with its cutting edge carrier section, which has a circumferential cutting edge 24 and free surface 25, by a defined measure, as follows from FIGS. 2, 4a, and 4b.

The cutting inserts 22 are in each case formed as plate- or rod-shaped cutting bodies consisting of a conventional hard material, which is known to the person of skill in the art, such as, e.g., PCD or CBN, or as composite body consisting of a hard metal carrier and a PCD or CBN coating and in each case have at least one circumferential cutting edge 24 and a circumferential free surface 25 connected to the circumferential cutting edge 24. Deviating from this, the cutting inserts 22 can additionally be embodied so as to cut on the front side, i.e. in each case have a (non-illustrated) front cutting edge and front free surface in addition to the circumferential cutting edge 24 and circumferential free surface 25.

In the shown embodiment, the cutting inserts 22 are in each case received in a positive manner on the assigned cutting web 20 in a seat 26 provided for this purpose, are supported on a support surface 27 forming the bottom of the seat in order to absorb the cutting forces and are fastened by means of soldering. The support surfaces 27 are in each case formed of a flat surface, which runs parallel to the tool axis 11 and which lies upstream of an assigned longitudinal sectional plane (i.e. “over center”) containing the tool axis 11 in the direction of rotation of the tool, but whereby the circumferential cutting edge 24 formed on the cutting insert 22 lies upstream of the longitudinal sectional plane (i.e. “over center”) containing the tool axis in the direction of rotation of the tool. The cutting insert 22 as a whole thus lies over center. It is important to point out at this point that the over center position of the cutting insert 22 is not crucial.

In the shown embodiment, the circumferential cutting edges 24 lie on a (non-illustrated) conical surface, which tapers slightly towards the shaft 13, around the tool axis 11. In the shown embodiment, as already mentioned, the cutting inserts 22 are further designed so as to cut circumferentially, i.e. for a milling. The front sides and corner bevels of the cutting inserts 22 thus do not cut. It is important to emphasize at this point that, alternatively to the shown embodiment, the machining tool can also be formed so as to cut on the front side and circumferentially, which results in the already mentioned further intended uses, e.g. drilling open, reaming, or drilling into solid.

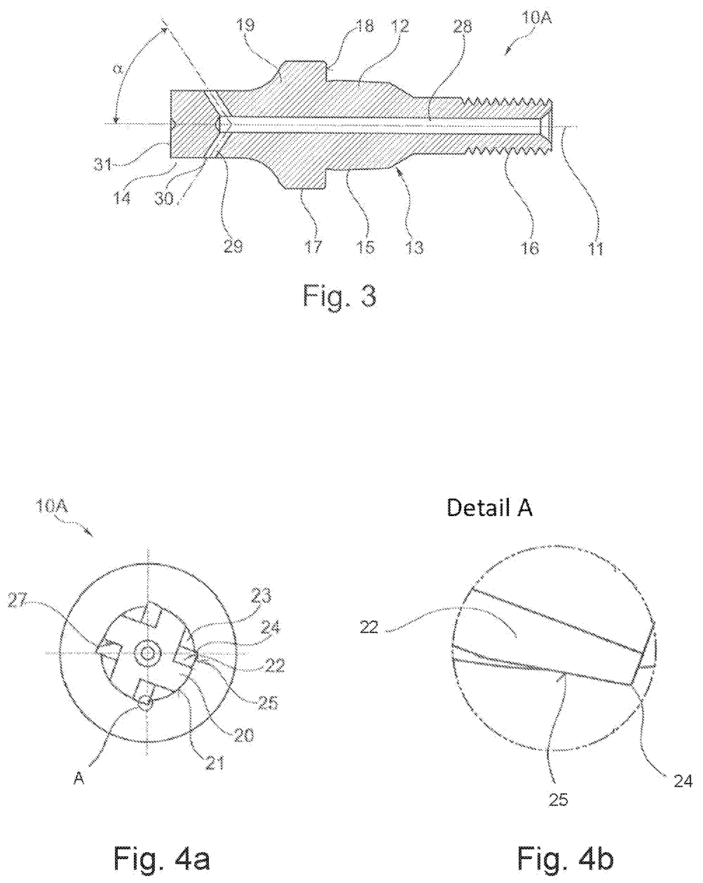

The machining tool has a coolant channel system, which is integrated into the tool body 12 and which, as it is shown in FIG. 3, has a main channel 28, which is guided along the tool axis, and at least one branch channel 29, which branches off from the main channel 28 and which is guided exclusively through the cutting web 22. FIG. 3 shows a branch channel 29 for each cutting web 22.

As shown in FIG. 3, each branch channel 29 ends in a mouth opening 30, which lies in the jacket surface 21 of the assigned cutting web 20. Viewed in the direction of rotation of the tool, the mouth openings 30 in each case lie downstream from the cutting insert 22 arranged on the assigned cutting web 20 and, viewed in the axial direction, in the region of the longitudinal extension of the circumferential cutting edge 24 of the cutting insert 22, which is arranged on the assigned cutting web 20. With respect to the cutting edge carrier sections of the cutting inserts 22, which have the circumferential cutting edge 24 and free surface 25, the jacket surfaces 21 of the cutting webs 20 are radially recessed, as it is shown in FIG. 4a, so that the mouth openings 30 in each case lie on a smaller diameter than the cutting carrier sections of the cutting inserts 22, which protrude radially beyond the jacket surfaces 21 of the cutting webs 20.

The central main channel 28 and the branch channels 29 are in each case formed as bores, which are guided in a straight line, whereby the main channel 28 is guided centrally through the tool body 12 along the tool axis 11 and ends at a defined distance (see FIG. 3) upstream of the tool front side 31. The branch channels 29 in each case lie in a longitudinal sectional plane containing the tool axis 11.

The branch channels 31 are in particular guided through the respective cutting web 20 so that, on the one hand, the end milling cutter is cooled by means of the heat dissipation, which is effected via the coolant flow through the cutting webs 20, and, on the other hand, which are dissipated directly and systematically in the direction of the tool front side 31 during a machining of a workpiece in the length region of the tool body 12, in which they are released from the machined workpiece. The exit angle α of the coolant jets, i.e. the direction of the branch channels 31 at least in the branch channel sections, which form the mouth opening 30, and the flow cross sectional surfaces of the branch channels 30 (at least in the region of the mouth openings) determine the flow direction and the flow pressure of the coolant jets at the mouth openings 30.

In the shown embodiment, the branch channels 30 are in each case placed at a defined angle α of 50° to 60°, preferably 55°, to the tool axis 11 and are aligned so that they are oriented away from the shaft 13 in the direction of the tool front side 31. The flow cross sectional surfaces of the main channel 28 and of the branch channels 29 are additionally in each case designed so that the flow pressure of the coolant jets escaping at the mouth openings 31 is in each case higher than the flow pressure of the coolant flowing through the main channel 29. This means that the flow cross sectional surfaces of the branch channels 29 (at least in the region of the mouth openings 30) as a whole, i.e. in sum, are smaller than the (smallest) flow cross sectional surface of the main channel 29.

Compressed air (e.g. 4 to 6 bar) or another common coolant (also referred to as cooling lubricant) on the basis of a compressed air-oil mixture can be used as coolant.

### Second Embodiment

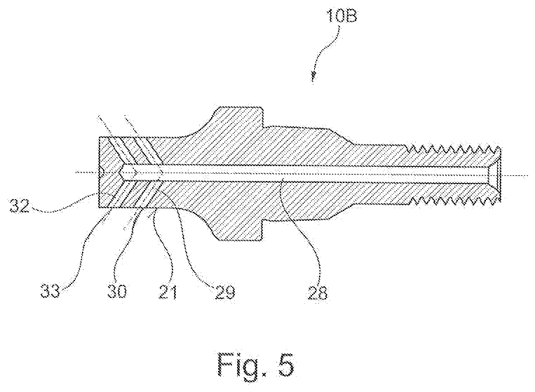

FIG. 5 shows a machining tool according to a second embodiment, which is again formed in an exemplary manner as end milling cutter 10B here, which only differs from the end milling cutter 10A according to the first embodiment in that two branch channels 29 and 32 are provided for each cutting web, which branch off from the central main channel 28 and which are guided parallel next to one another through the cutting web all the way to a mouth opening 30 or 33, respectively, on the jacket surface 21 of the cutting web.

Deviating therefrom, more than two branch channels, which branch off from the central main channel and which are preferably guided parallel next to one another through the cutting web all the way to a respective mouth opening at the jacket surface of the cutting web, can also be provided in a non-illustrated further embodiment for each cutting web.

The disclosure thus creates a one or multiple cutting edge machining tool comprising an integrated coolant channel system. The coolant supply of the cutting part takes place by means of a channel system, which is formed exclusively in the tool body. The channel system thus no longer leads through the cutting insert or inserts, which are held on the tool body. The mouth opening of each branch channel lies in a circumferential jacket surface of an assigned cutting web. The branch channel or channels thus no longer engage with the cutting insert or inserts arranged on the cutting web.

The solution according to the disclosure can generally be embodied on each generic machining tool, which can in particular be used for milling, but alternatively also for reaming and/or drilling or drilling open. The machining tool can be driven so as to rotate or can be used in a stationary manner for these purposes.

The number of the cutting webs is not limited to four, as it is the case in the shown embodiments. One cutting web is generally sufficient. In terms of a very smooth running, two or more cutting webs can be advantageous.

Several cutting webs can be distributed around the tool axis at regular intervals. In terms of a very smooth running, however, the several cutting webs can also be arranged around the tool axis with an irregular distribution.

Depending on the intended use of the machining tool, the cutting inserts, deviating from the shown embodiments, cannot only be formed so as to cut circumferentially, but on the front side and circumferentially.

Instead of clamping grooves running in a straight line, the machining tool can have helically running clamping grooves.

### LIST OF REFERENCE NUMERALS

10A, 10B end milling cutter
11 tool axis
12 tool body
13 shaft
14 cutting part
external conical clamping section
16 external thread section
17 collar
18 stop surface
19 tapering section
cutting web
21 jacket surface
22 cutting insert
23 clamping groove
24 circumferential cutting edge
circumferential free surface
26 seat
27 support surface
28 main channel
29 branch channel
mouth opening
31 tool front side
32 branch channel
33 mouth opening
α exit angle

What is claimed is:

1. A machining tool (10, 40), comprising:
a tool body (12), which extends along a central tool axis (11) and which has at least one cutting web (20), which carries
a cutting insert (22), which protrudes radially beyond a circumferential jacket surface (21) of the cutting web (20) and which cuts at least circumferentially, and
an integrated coolant channel system, which has
a main channel (28) guided along the tool axis (11) and, for each cutting web (20),
at least one branch channel (29, 29a, 29b), which branches off the main channel (28) and which is guided through the cutting web (20),
wherein the at least one branch channel (29, 29a, 29b) has a mouth opening (30, 30a, 30b), which lies in the jacket surface (21) of the cutting web (20).

2. The machining tool (10, 40) according to claim 1,
wherein the at least one branch channel (29, 29a, 29b) is placed at a defined angle (α) to the tool axis (11) at least in a length section forming the mouth opening (30, 30a, 30b).

3. The machining tool (10, 40) according to claim 2,
wherein at least the length section forming the mouth opening (30, 30a, 30b) is placed to the tool axis (11) so that it is oriented in the direction of a tool front side (31).

4. The machining tool (10, 40) according to claim 3,
wherein at least the length section forming the mouth opening (30, 30a, 30b) is placed at an angle (α) in the range of 50° to 60° to the tool axis.

5. The machining tool (10, 40) according to claim 1,
wherein the main channel (28) and/or the at least one branch channel (29, 29a, 29b) are/is embodied in a straight line.

6. The machining tool (10, 40) according to claim 1,
wherein the mouth opening (30, 30a, 30b) of the branch channel (29, 29a, 29b) lies in a region of a length extension of the cutting insert (22), viewed in the axial direction of the tool body (12).

7. The machining tool (10, 40) according to claim 1,
wherein the main channel (28) is guided centrally through the tool body (12) along the tool axis (11).

8. The machining tool (10, 40) according to claim 1,
wherein the main channel (28) ends at a defined distance upstream of a tool front side (31).

9. The machining tool (10, 40) according to claim 1,
wherein the branch channel (29, 29a, 29b) lies in a longitudinal sectional plane containing the tool axis (11).

10. The machining tool (10, 40) according to claim 1,
wherein at least in a region of the mouth opening (30, 30a, 30b), a cross sectional surface of the at least one branch channel (29, 29a, 29b) is designed so that a flow pressure of a coolant jet escaping at the mouth opening (30, 30a, 30b) is higher than a flow pressure of a coolant jet flowing through the main channel (28).

11. The machining tool (10, 40) according to claim 1,
wherein the tool body (12) has four cutting webs (20) with even distribution around the tool axis (11), which each carry a cutting insert (22).

12. The machining tool (10, 40) according to claim 1,
wherein the tool body (12) has a shaft (13) for clamping into a tool holder and a cutting part (14) having the at least one cutting web (20), whereby the main channel (28) is guided through the shaft (13) into the cutting part (14).

13. The machining tool (10, 40) according to claim 1,
wherein the at least one cutting web (20) has a support surface (27), which carries the cutting insert (22) and which runs parallel to the tool axis (11) and which lies downstream from a longitudinal sectional plane containing the tool axis (11) in the direction of rotation of the tool.

14. The machining tool (10, 40) according to claim 1,
wherein a circumferential cutting edge (24) formed on the cutting insert (22) lies upstream of a longitudinal sectional plane containing the tool axis (11) in the direction of rotation of the tool.

15. The machining tool (10, 40) according to claim 1,
wherein the machining tool is a milling, reaming, or drilling tool.
